(19) United States
(12) Patent Application Publication
(10) Pub. No.: US 2010/0127013 A1
(43) Pub. Date: May 27, 2010

(54) DVD KIOSKS

(76) Inventor: Jon F. Butler, Salt Lake City, UT (US)

Correspondence Address: KENNETH E. HORTON;KIRTON & MCCONKLE, 60 EAST SOUTH TEMPLE, SUITE 1800, SALTLAKE CITY, UT, 84111, US

(21) Appl. No.: 12/324,396

(22) Filed: Nov. 26, 2008

(51) Int. Cl. G07F 11/00

(52) U.S. Cl. 221/1; 221/199

(57) ABSTRACT

Distribution devices for creating and dispensing digital content to a user are described. The distribution devices (i.e., a kiosk) contain an apparatus for manufacturing and dispensing a desired medium (i.e., DVD) for any desired type of digital content or media (i.e., a movie or a song) on demand by a user. The distribution devices can be connected to any electronic communications network that allows that media to be downloaded to a specific distribution device, if needed. Thus, a user can select the media (i.e., a desired movie) that may not be currently available at that specific distribution device. That media can then be downloaded from the electronic communications network, the medium containing the media created, and then the medium dispensed to the customer. Thus, the customer's selection of any desired media can be increased and costs for operating the distribution devices can be reduced. Other embodiments are described.

### CROSS-REFERENCE TO RELATED APPLICATION

This application claims priority of U.S. Provisional Application Ser. No. 60/982,195, filed on Oct. 24, 2007, the entire disclosure of which is incorporated herein by reference.

### FIELD

The application generally relates to apparatus for creating and dispensing digital media. In particular, this application relates to kiosks for creating and dispensing digital content on a digital video disk (DVD) to a user.

### BACKGROUND

Currently, consumers can rent DVDs containing movies from kiosks. For example, Red Box Automated Retail LLC operates a kiosk system that allows a consumer to select and rent a DVD containing movies from kiosks that are located in various retail locations. On arriving at the kiosk, the consumer is presented with a selection of movies from which they can browse for the desired movie. The selection of movies is limited to those DVDs currently in inventory at the kiosk at which the consumer is located.

Once the user pays for the rental, the DVD is ejected for the consumer's use. The consumer pays for the rental using a credit or debit card for the initial rental period (i.e., 24 hours). If the DVD is not returned within that time period, another payment is automatically made to the credit or debit card for another rental period. These additional charges continue until such time as the full purchase price has been paid for the DVD, at which time the DVD is considered to have been purchased by the consumer and it does not need to be returned to the kiosk. Unfortunately, such kiosks can be limited in manner ways in their use and function.

### SUMMARY

This application describes distribution devices for creating and dispensing digital content to a user. The distribution devices (i.e., a kiosk) contain an apparatus for manufacturing and dispensing a desired medium (i.e., DVD) for any desired type of digital content or media (i.e., a movie or a song) on demand by a user. The distribution devices can be connected to any electronic communications network that allows that media to be downloaded to a specific distribution device, if needed. Thus, a user can select the media (i.e., a desired movie) that may not be currently available at that specific distribution device. That media can then be downloaded from the electronic communications network, the medium containing the media created, and then the medium dispensed to the customer. Thus, the customer's selection of any desired media can be increased and costs for operating the distribution devices can be reduced.

### BRIEF DESCRIPTION OF THE DRAWINGS

The following description can be better understood in light of the Figures, in which:

FIG. 1 depicts an exemplary system for delivering digital content to a user;

FIG. 2 illustrates the components in some embodiments of an exemplary distribution device;

FIG. 3 illustrates some methods for delivering digital content to a user using an exemplary distribution device;

FIG. 4 illustrates an exemplary computer system that can be used in delivering digital content to a user.

FIG. 5 illustrates an exemplary computer network that can be used in delivering digital content to a user.

Together with the following description, the Figures may demonstrate and explain the principles of the distribution devices for creating and dispensing digital content to a user. In the Figures, the thickness and configuration of components may be exaggerated for clarity. The same reference numerals in different Figures represent the same component.

### DETAILED DESCRIPTION

The following description provides specific details in order to provide a thorough understanding. The skilled artisan, however, would understand that the distribution devices and methods can be practiced without employing these specific details. Indeed, the distribution devices for creating and dispensing digital content to a user can be practiced by modifying the illustrated devices and methods and can be used in conjunction with apparatus and techniques conventionally used in the industry.

The distribution device can create and dispense a medium containing any desired digital content. The distribution device can be one of a plurality of distribution devices that are situated at a plurality of locations. In some embodiments, multiple distribution devices can be located at a single location.

The distribution devices can distribute any type of digital content. The types of digital content are virtually unlimited. Examples of the digital content include music, movies, video games, software, mobile phone ring tones, electronic books, advertising, and other types of content. The format in which the digital content is stored is also virtually unlimited. Examples of the types of digital formats include pdf, doc, xls, jpeg, tiff, gif, xbm, pnm, mpeg2, mpeg4, mp3, oma, m4a, wma, wmv, mov, wav, and avi, as well as combinations thereof. The digital content can also be provided in any known language.

The digital content can be made available to the user using any medium known in the art. In some embodiments, the medium comprises an audio CD, DVD or similar video or data disc, writeable data CD such as WORM or CD-RAM, magnetic and solid state storage devices that communicate with the distribution device via any means known in the art. In some aspects, the digital content can be placed on an electronic device that can include plug-ins or software that has advertising integrated and can be used to play the content received. In some embodiments, the medium can comprise a device for receiving (a receiving device) the digital content as described herein.

The distribution device can be any type of device known to distribute digital content to a user. Examples of such devices include kiosks, vending machines, automated teller machines, coin- or card-operated communications machines (e.g., telephone machines/booths), or remote terminals located in a secure or unsecured public space such as a library, hallway, or outdoor vending area. In some embodiments, the distribution devices can be configured as a kiosk. The kiosk can receive the digital content (i.e., the movie), create a medium (i.e., a DVD) to contain the digital content (i.e., “burn” the movie onto the DVD), and then dispense that medium to a user (dispense the DVD to a user).

The kiosk provides a point-of-sale (or rental) experience for any user, including both actual and potential purchasers, renters, consumers, or other customers of the digital content. Any person can be a user by interacting with the kiosk, whether by purchasing (which including renting) content or merely viewing the kiosk and/or the content on the kiosk, such as by sampling music contained in the kiosk. In some embodiments, the kiosk can limit the time of interaction with a given user, can limit the viewing of a specific user, and/or limit the digital content available to a specific user. The kiosk used in the system can be any kiosk known in the art or the kiosks described herein. In some embodiments, the kiosk may physically display any known advertising, such as posters, banners, or adhesive advertisements. The kiosk may also be used in conjunction with products as a point-of-purchase display.

The kiosk can contain any combination of number of video displays. In some embodiments, the kiosk contains two video displays, a first video display that displays advertising messages and a second video display that displays menus, samples of content, and related information appropriate to affect a purchase by the user of the content made available through the kiosk. In other embodiments, though, the kiosk can contain only one video display, as well as three or more video displays. The video display can comprise any known displays, including LED displays, TFT displays, LCD displays, CRT displays, touch screens, and combinations thereof.

The kiosk can also contain multiple input and output devices appropriate to interact with a user, display or perform the content stored on the kiosk, and complete a sales or rental transaction related to the digital content. These input and output devices may include, for example, one or more of any of the following: a keyboard; a mouse; a trackball; a joystick; a touch screen; a label maker; an automatic coupon feeder; a barcode scanner; an image scanner; biometric scanning devices such as a fingerprint, voiceprint, hand geometry, or retinal/iris scanner; a Compact Disc reader; a Compact Disc writer; a video disk reader; a video disk writer; and media device connectivity, including a USB port, an IEEE-1394 FireWire port, a SecureDigital (SD) port, a CompactFlash port, a PCMCIA port, a MemoryStick port, a laser printer, a receipt printer, a video camera, a camera, an audio recorder, a credit/debit/gift card reader, a cash acceptor, a coin acceptor, a check acceptor, a jewel case ejector, a phone docking station, speakers, voice recognition device, signature verifier, facial recognition device, Braille input device, bubble sheet/multiple choice form scanner (such as a Scantron machine), Bluetooth communications, Wi-Fi communications, Wi-Max communications, SMS communications, and other input or output device known in the art. Furthermore, additional input, output, and storage technologies known in the art may be integrated with the kiosk, including any and all mobile or portable devices.

The kiosk can also include a controlling device that operates the video displays, interacts with input and output devices, and communicates with other kiosks (or components in an electronic network), in real-time or as needed. In some embodiments, the controlling device includes two or more computers, either sharing or dedicated to the needed tasks requisite to controlling operation. In some configurations, one computer handles the display, selection, and processing of content purchase transactions and a second computer handles the remainder of the tasks required of the kiosk.

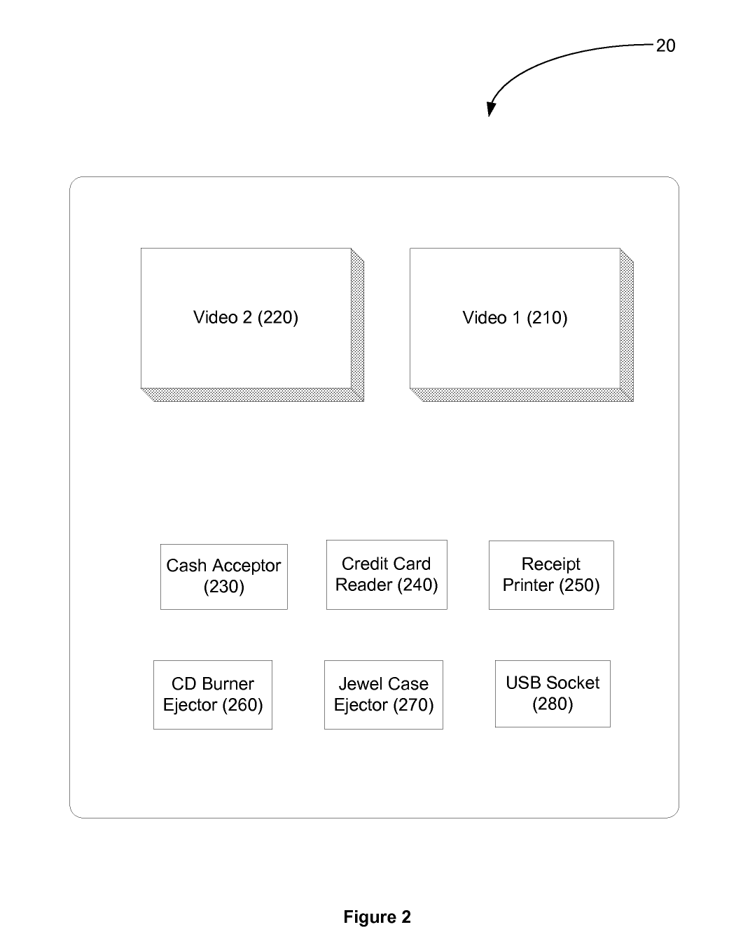

FIG. 2 illustrates one example of kiosk. In FIG. 2, kiosk 20 contains a video display 210 on which advertising or promotional messages are displayed; a video display 220 comprising a touch screen device through which a user may view and select content; a cash acceptor 230 through which a user may make payment for content; a credit card reader 240 through which a user may make payment for content; a receipt printer 250 that dispenses a paper receipt of a transaction when content is purchased; a DVD burner ejector 260 that dispenses a DVD containing content selected by a user during a purchase transaction; a jewel case ejector 270 that dispenses an empty jewel case for holding the DVD; and a USB socket 280 to which a user may connect a receiving device for delivery of content, as described herein. In some embodiments, the kiosk 20 could eject the DVD that has been placed in a jewel case (or a DVD sleeve). As noted previously, a kiosk 20 may contain different—or additional—components than those shown in FIG. 2, including an end unit that comprises a mobile or portable device.

The kiosk 20 may contain any type of dispensing compartment to dispense the medium. In some configurations, the kiosk 20 may contain may be a small slot that dispenses an SD card (that was also purchased) with selected media loaded onto the card. The kiosk 20 would automatically engage the chip, download the desired files onto the chip, and then dispense the chip through this small slot. As well, a slot may be provided to give a consumer a location to insert the user's SD card and then extract it form the kiosk once the digital content has been transferred to it. Where a small device (such as MicroSD cards) is used as the receiving device, an adaptor may be formed on the front of the kiosk 20 that communicates with that device. The kiosk may also contain a wireless component for transferring the purchased digital content to the receiving device of a user.

In some embodiments, the video displays of the kiosk 20 incorporate known touch screen technology. Thus, it can provide a user interface that presents a visual display of pertinent information during the interaction and distribution processes, as well as operate as a user interface for entry of user commands. In some embodiments, the kiosk 20 also includes any known audio technology, such as speakers or headphones.

The kiosk 20 can include a user-friendly interface, including a graphical user interface with a touch screen capability. If desired, multiple interfaces can be incorporated in the kiosk situated at high traffic locations, such as by being positioned on each side of the kiosk. The user interface comprises a hierarchy of pages that a user navigates through to accomplish different tasks. For example, a user may search for a specific song, title or artist; once the user's selection is found, the selection may be sampled, and eventually purchased or rented. The same process applies to all digital content types where a user can interact with the kiosk 20 to accomplish different tasks associated with the content.

The inside of the kiosk 20 can also contain a storage unit for blank medium without digital content on it, including blank DVDs and/or cases for the DVDs. As well, the kiosk can contain a storage unit for storing DVD that contains digital content that has already been created on the DVD. As well, the storage unit could store DVDs that have been returned by a user. Any storage unit(s) known in the art can be used for these functions.

The kiosk 20 also contains a mechanism for moving the medium from the storage location to the ejector 260 to be dispensed (and later from the ejector to a storage unit if has been rented and is being returned by the user). The kiosk can contain any other known components that aid in creating and/or dispensing medium to a user or optionally allowing rented medium to be returned. See, for example, U.S. Pat. No. 7,234,609.

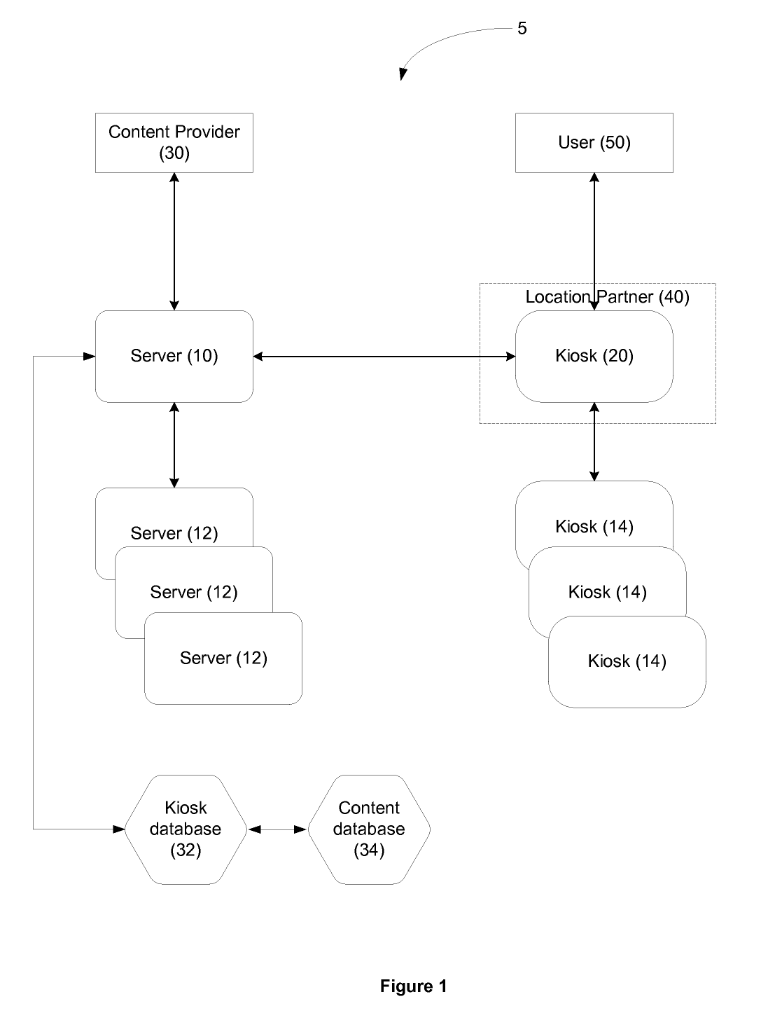

The distribution device can be part of a system that can deliver the digital content (or content) from another location to the distribution device. Thus, the system contains a storage device in a first location where the digital content can be stored, the distribution device in a second location for delivering the digital content to a user, an optional receiving device for receiving the digital content that has been distributed (when the appropriate type of medium has been used), and means for communicating with the user who is optionally not located at the device. In some embodiments, the systems for delivering the digital content to the kiosk can be illustrated in FIG. 1. As depicted in that Figure, the system 5 contains a first (or storage) device in a first location that stores the digital content and transfers the digital content to a second (or distribution) device in a second location. The digital content can be distributed from the second device to a user via the receiving device if it is needed.

Prior to discussing the details of system 5, it should be understood that the following description is presented largely in terms of steps and operations that may be performed by conventional computer components. These computer components, which may be grouped in a single location or distributed over a wide area, generally include computer processors, memory storage devices, display devices, input devices, etc. In circumstances where the computer components are distributed, the computer components are accessible to each other via communication links, such as those illustrated in FIG. 1. The system 5 could equally operate within a computer system having a fewer or greater number of components than those illustrated in FIG. 1. Thus, the depiction of system 5 should be taken as illustrative and not limiting. For example, the system 5 could implement various services components and peer-to-peer network configurations to implement at least a portion of the processes.

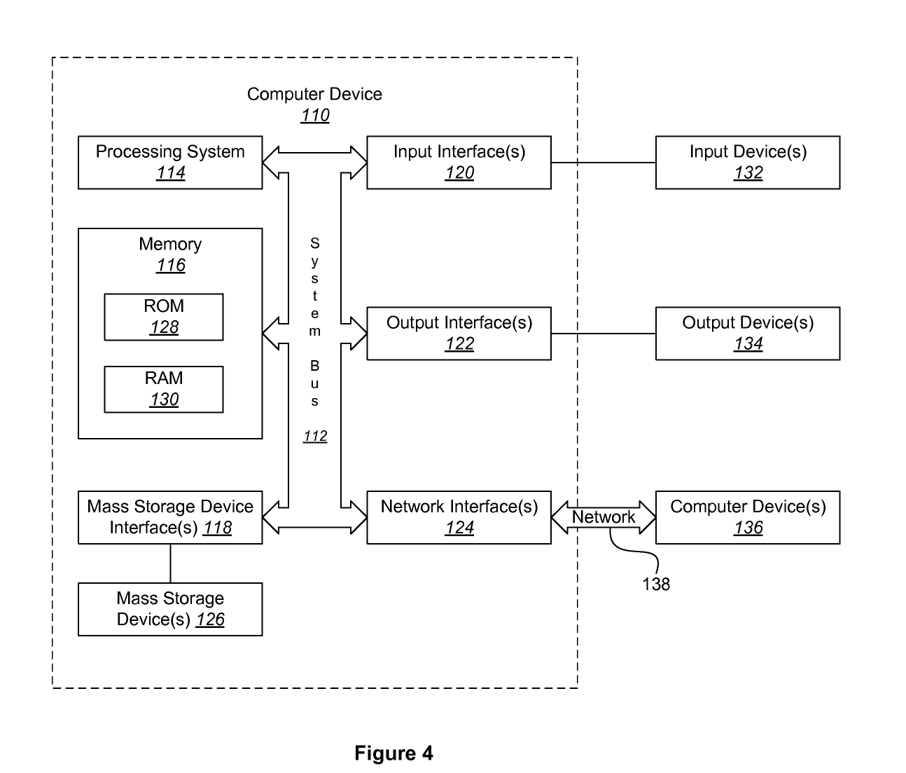

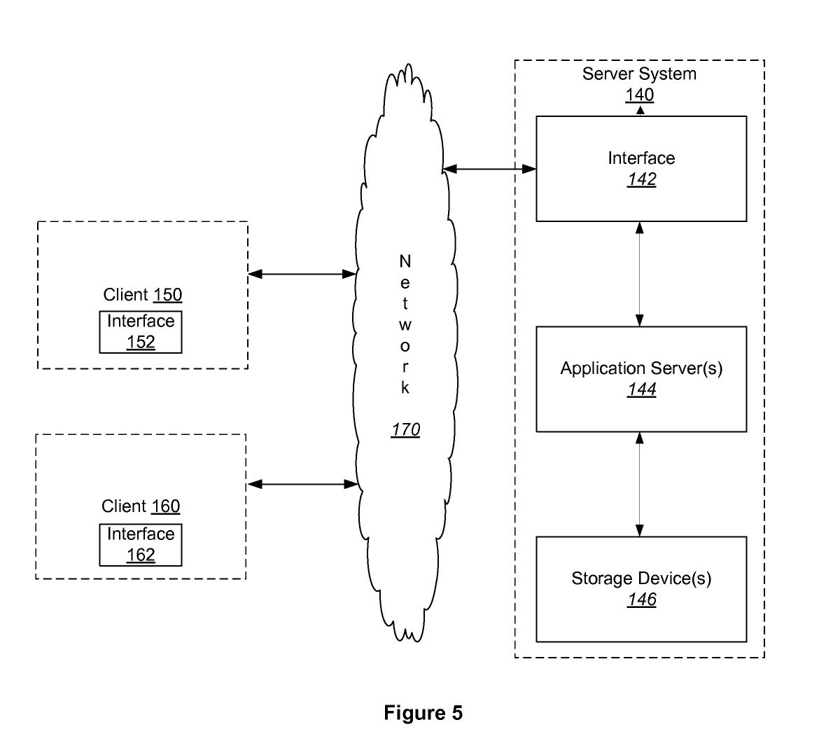

In some embodiments, FIGS. 4-5 illustrate one computer operating environment in which the system may be implemented. These embodiments contain one or more computer readable media that may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 4, the system includes computer device 110, which may be a general-purpose or special-purpose computer. For example, computer device 110 may be a personal computer, a notebook computer, a tablet computer, a personal digital assistant (“PDA”), or other hand-held device, a workstation, a minicomputer, a mainframe, a supercomputer, a multi-processor system, a network computer, a processor-based consumer electronic device, or the like.

The computer device 110 includes system bus 112, which may be configured to connect various components thereof and enables data to be exchanged between two or more components. The system bus 112 may include one of a variety of bus structures including a memory bus or memory controller, a peripheral bus, or a local bus that uses any of a variety of bus architectures. Typical components connected by system bus 112 include processing system 114 and memory 116. Other components may include one or more mass storage device interfaces 118, input interfaces 120, output interfaces 122, and/or network interfaces 124.

The processing system 114 includes one or more processors, such as a central processor and optionally one or more other processors designed to perform a particular function or task. It is typically processing system 114 that executes the instructions provided on computer readable media, such as on memory 116, a magnetic hard disk, a removable magnetic disk, a magnetic cassette, an optical disk, or from a communication connection, which may also be viewed as a computer readable medium.

The memory 116 includes one or more computer readable media that may be configured to include or includes thereon data or instructions for manipulating data, and may be accessed by processing system 114 through system bus 112. The memory 116 may include, for example, ROM 128, used to permanently store information, and/or RAM 130, used to temporarily store information. ROM 128 may include a basic input/output system (“BIOS”) having one or more routines that are used to establish communication, such as during start-up of computer device 110. RAM 130 may include one or more program modules, such as one or more operating systems, application programs, and/or program data.

One or more mass storage device interfaces 118 may be used to connect one or more mass storage devices 126 to system bus 112. The mass storage devices 126 may be incorporated into or may be peripheral to computer device 110 and allow computer device 110 to retain large amounts of data. Optionally, one or more of the mass storage devices 126 may be removable from computer device 110. Examples of mass storage devices include hard disk drives, magnetic disk drives, tape drives and optical disk drives. A mass storage device 126 may read from and/or write to a magnetic hard disk, a removable magnetic disk, a magnetic cassette, an optical disk, or another computer readable medium. Mass storage devices 126 and their corresponding computer readable media provide nonvolatile storage of data and/or executable instructions that may include one or more program modules such as an operating system, one or more application programs, other program modules, or program data.

One or more input interfaces 120 may be employed to enable a user to enter data and/or instructions to computer device 110 through one or more corresponding input devices 132. Examples of such input devices include a microphone, a joystick, a game pad, a satellite dish, a scanner, a camcorder, a digital camera, a tactile input device, and the like. Some examples of tactile input devices can include a keyboard and alternate input devices, such as a mouse, trackball, light pen, stylus, touchpad, touch-screen, or any other suitable pointing device. Similarly, examples of input interfaces 120 that may be used to connect the input devices 132 to the system bus 112 include a serial port, a parallel port, a game port, a universal serial bus (“USB”), a firewire (IEEE 1394), or another interface.

One or more output interfaces 122 may be employed to connect one or more corresponding output devices 134 to system bus 112. Examples of output devices include a speaker, a printer, a visually perceptible output device (e.g., a monitor, display screen, or any other suitable visualization device), and the like. A particular output device 134 may be integrated with or peripheral to computer device 110. Examples of output interfaces include a video adapter, an audio adapter, a parallel port, and the like.

One or more network interfaces 124 enable computer device 110 to exchange information with one or more other local or remote computer devices, illustrated as computer devices 136, via a network 138 that may include hardwired and/or wireless links. Examples of network interfaces include a network adapter for connection to a local area network (“LAN”) or a modem, wireless link, or other adapter for connection to a wide area network (“WAN”), such as the Internet. The network interface 124 may be incorporated with or peripheral to computer device 110. In a networked system, accessible program modules or portions thereof may be stored in a remote memory storage device. Furthermore, in a networked system computer device 110 may participate in a distributed computing environment, where functions or tasks are performed by a plurality of networked computer devices.

The system may be operated in networked computing environments with many types of computer system configurations. FIG. 5 represents some embodiments of a networked environment that includes clients 150 and 160 connected to a server system 140 via a network 170. While FIG. 5 illustrates an embodiment that includes two clients connected to the network, alternative embodiments include one client connected to a network or many clients connected to a network. Moreover, some embodiments also include a multitude of clients throughout the world connected to an electronic network, where the network can be a wide area network, such as the Internet.

Returning to FIG. 1, the first location can be located anywhere desired by the operator of the system 5, i.e., in a central location (with central not referring to the geographic location). The first device acts as a repository for any desired digital content. The first device also permits an operator or administrator of the system 5 to manage all of its operations at a centralized location, permitting roll-out of digital content (and the related materials described herein) across all or select distribution devices and real-time feedback from each distribution device as to its use and functionality.

Any device that can operate in this manner can be used as the first device. One example of the first device comprises a server 10. Any type of server known in the art can be used as server 10. Examples of servers that can be used include a computer running a UNIX-style operating system, a computer running a Microsoft Windows operating system, or a personal computer workstation. The server 10 comprises any storage component on which the digital content can be stored. Examples of storage components include optical storage discs, DVD-RAM discs, and traditional magnetic hard disc drives.

Another example of a storage component includes any known database (or combination of databases). The database stores customer information, information regarding the digital content viewed or purchased and any user interaction with the system. For example, the database stores data regarding the content inventory at each of the distribution devices. The database can also store sales information, user information, and transactional information. The database may be a Microsoft SQL database, a Microsoft Access database, an Oracle database, a MySQL database or combinations thereof. In some embodiments, the server can contain a kiosk database 32 (or module of a database) for managing and monitoring the distribution devices (kiosks) and a digital content database 34 (or module of a database) for managing and monitoring the digital content.

In some aspects, multiple servers 12 may be connected together to make a server cluster. Using a server cluster permits sharing of information regarding the content stored on each server 10 and each transaction the server 10 has recorded. By using a server cluster, the system 5 is always operational, regardless of the location of a particular component on the network that connects the components (such as the internet). The server cluster can contain a primary cluster, which handles all critical tasks, with minor functions being routed to a secondary cluster. With this configuration, if the primary cluster is not operational, most functions can be handled by the secondary cluster. A server cluster also allows for large-scale deployment and interoperability, as well as data that can be stored on the network in multiple points of co-location.

The software components required for operating the server 10 may be included on a single server or on multiple servers, with each server implementing one or more tasks and communicating among themselves using standard networking protocols. Non-limiting examples of the server-focused tasks using the software components that may be implemented on one or more servers 10 include those of e-mail server; Web server; file server; purchase transaction authentication server; transaction push server; monitoring server; content management server; content synchronization server; content security server; and advertising/promotional message server.

The digital content may be provided internally (by the entity that controls or operates the system 5), or externally by one or more third parties that may be the copyright owners of the content or that act on behalf of the owners of the content (collectively, content providers 30). Non-limiting examples of content providers 30 include music publishers, video publishers, recording companies, movie studios, television studios, book publishers, artists, performers, end-users, mobile telephone companies, video game manufacturers, and advertisers. Content providers 30 may provide the content to the server using any known mechanism, including via wired or wireless network connections known in the art or via other methods, such as merely providing a CD or DVD to the operator of the system. In some embodiments, the content providers 30 can provide (or upload) the digital content to a distribution device(s), which can then be transferred to the server 10.

Optionally, the digital content can contain instructions indicating how the content may be used, distributed, sold, transmitted, or otherwise processed (use instructions). The server 10 can convert such use instructions into digital rights management (DRM) information that can be associated with any desired content. The DRM information may include any number or combination of restrictions, including those that are enabled by a DRM technology and that are selected by a content provider 30. Non-limiting examples of DRM restrictions include a restriction that visual or textual content not be printed in hardcopy; a restriction that copy-and-paste functions are disabled for textual content; a restriction that a music file may not be played after a certain date; a restriction that a music file or video file may only be played a fixed number of times; and a restriction that a file may only be copied to another device a fixed number of times. Other examples include variable pricing, variable billing, and variable payment methods.

The DRM information may be provided by a third party (such as content provider 30 or location partner 40), content provider, or by the operator of the system 5. Either may assign a unique transactional ID to each piece of digital content. This unique transactional ID correlates to a set of use instructions and DRM specifications to control how the associated content is managed on devices, such as on the server 10, as described herein. The digital content may therefore contain metadata (i.e. metatags), use instructions, and a transactional ID.

The metadata (i.e., metatags) can correspond to information about any desired content, such as a genre of music or movie, an artist, a content provider, content release date, or otherwise. The metatags may be provided by a content provider 30, location partner 40, or created by the operator of the system. The metatags may indicate the use instructions for all content that is provided, with distinct use instructions for each piece of content, or with use instructions based on parameters that can be used to classify content. In one example of use instructions, a content provider 30 may indicate that music performed by musical artist A may be redistributed freely, without restriction, music performed by musical artist B may be redistributed freely when purchased at a set price, and music performed by musical artist C may be redistributed in a manner that permits the music to be copied to another computer three times, after which the music may not be copied to another computer, but only played (performed) on a computer where it is stored. In another example, the metadata could also include previews of movies or advertisements.

The digital content may optionally be encrypted in a manner to increase security of the content during storage on a server 10 or on a distribution device, or during transfer between a content provider 30 and a server 10, between a server 10 and the distribution device, or between the distribution device and the receiving device. Any number of encryption methods known to those in the art may be used to implement this feature. Examples of such encryptions include both symmetrical and asymmetrical encryption using a variety of methods, including RSA, DES, Triple DES, AES, Blowfish, ElGamal, RC4, and others.

When the distribution device is placed in a location that is remote from the first device, a location partner 40 can optionally be used in the system 5 as depicted in FIG. 1. The location partner 40 comprises an individual or entity that provides a space where the delivery device may be physically located. Non-limiting examples of such location partners include owners, operators or managers of airports, bars, clubs, schools, gyms, stadiums, arenas, amusement parks, military bases, retail centers, retail stores or shops, convenience stores, eating establishments, correctional facilities, passenger ships, military ships, travel centers or stops, and libraries.

A location partner 40 may provide this space without charge, as a service to individuals that visit the space where the delivery device is placed. Or the location partner 40 may provide this space in exchange for a fee of some type, or in exchange for advertising time or space on the distribution device, or for other benefits. In some embodiments, the location partner 40 may control or limit the content that is available via the distribution device. In other embodiments, the location partner can also control the advertising at the distribution device.

The system 5 also contains a distribution device (kiosk) that can be located in a second location that is optionally remote from the first location. The distribution device receives the content from the first or storage device and then distributes that content to a user (i.e., a purchaser). Any device operating in this manner can be used as the distribution device. In some embodiments, the distribution device comprises any known vending machine or any known kiosk, such as the kiosks described herein.

The various components of the system 5 can be electronically connected to each other using any means known in the art. In some embodiments, the system 100 contains a computer network. Computer networks are well known in the field of communications. Computer networks may include communication links that extend over a local area or a wide area, or even be global. Examples of these communication links include Ethernet, frame relay, DSL, satellite uplink, cable modem, analog modem, fiber channel, infrared and microwave transmissions, wireless communications of various types, SMS, and other wired or wireless networking technologies known in the art. Such connections may also be constructed through a publicly accessible network, such as the Internet, so long as appropriate security measures, as are known in the art, are used to prevent unauthorized access to the content that passes across the connection. A private network connection may also be used in order to reduce the reliance on such security measures and to further ensure the integrity of content that is transferred via this connection.

The various components of the system 5 are able to communicate with each other whenever needed. In some embodiments, the server 10 and any kiosk 20 may communicate at regular or scheduled intervals, in real-time, or in an ad hoc manner according to needs that arise as determined by the server 10 or the kiosk 20. Since actual real-time communication may be limited by the transmission speeds available, the communication may be on a substantial or near real-time basis.

In some embodiments, the various components of the system need not be electronically connected. For example, the kiosk 20 need not be connected to the server 10 on a continuous basis. Rather, the kiosk can operate in a stand-alone mode, with digital content being transferred to the kiosk 20 via non-networked means, and purchase transactions and data being collected via non-networked, intermittent means. A stand-alone kiosk 20 can be used, for example, when security procedures or network connectivity are not available, such as a kiosk 20 located on a military base in a different country than the server 10 from which it would otherwise receive content.

The systems described above can be used to transfer the digital content from the first device to the distribution device, where it then can be optionally distributed or dispensed to an individual user (such as a purchaser or renter) via a receiving device. While the digital content can be transferred by the system in any manner, in some aspects, it can be transferred in a semi-dynamic manner, dynamic, or even static manner. The digital content can also be transferred to any distribution device (or group of devices) at once or one at a time.

When the digital content is transferred from the server to the kiosk, the operator of a server 10 may customize which content (or category, group of content, or advertising) is transferred, customize which content is transferred from a server 10 to a particular kiosk 20 (or to a collection of multiple kiosks 14), as well as customize the billing.

When a user views the kiosk, purchases content, or otherwise interacts with the kiosk, the kiosk may collect any desired type of data (collected data). Some examples of collected data may include data about the individual user (user data), data about the user's interaction with the kiosk (kiosk data), data concerning the demographics of the kiosk location (location or demographic data), financial data, and so forth. The kiosk (or other distribution device) may collect the data in any manner known in the art.

For example, during the user's interaction with the kiosk, the kiosk may gather user data. User data may include any information that relates to the user and/or the user's activities. One example of user data may include conversion data, such as pages viewed, images viewed, color schemes viewed, time of viewing, time of viewing in relation to purchase, content or item(s) purchased/downloaded, requests made, demos/games played, registrations, signups, advertisements viewed, and so forth. Another example of user data may include user browsing activities, such as content viewed, content selected, time spent viewing different content, and total interaction time. Yet another example of user data may be demographic information, such as the user's age, sex, ethnicity, race, marital status, household size, schooling/education, income, profession, languages spoken, citizenship, and the like. Still another example of user information may include survey data, such as consumer satisfaction surveys, event expectation surveys, post-event evaluation surveys, polling/voting data, and so forth. Another example user data may include user preference data, such as user selected color schemes, content preferences, advertisement preferences, e-mail preferences, and the like. Another example of user data includes user-indicated items of interest, such as forms and genres of entertainment and hobbies. In yet another example, user data may include user account information, such as username, password, address, phone number, e-mail address, unique login identifiers, cookies, user specific survey/conversion data, etc. In still another example, user data may include biometric data, such as fingerprints, voiceprints, hand geometries, retinal/iris scans, signature verifications, facial recognitions, video feed of end-user, pictures taken of end-user, audio recordings, and the like. Moreover, additional information may be collected and/or extrapolated from the any information/data that has been input by the user.

In some embodiments, the data obtained from the user can include the user's email account. That account can be used to further customize the kiosk experience for the user and/or used for a user to join a community of users. As well, that email account can be used to allow the user to receive additional electronic advertising, including notices of upcoming content, events, products, and similar topics. The user's email account may also be used when sharing the information among a community to which the user belongs. In some instances, the user can have a membership whether or not the user has an email account. For those users having a membership, the interaction can be customized. The member can enter his/her membership when prompted and can then be presented with customized menus based on past interaction/sales patterns.

The collected data also includes kiosk data. The kiosk data can include any of the user's interaction with the kiosk including, as non-limiting examples, the following: the areas of the content navigation system visited by the end-user; the advertising content displayed immediately prior to and during the end-user's interaction with the kiosk; the advertising content displayed immediately prior to and during the end-user's purchase from the kiosk; the nature of the delivery device selected by the end-user; method of payment, and others. For instance, the kiosk data may also include sales transaction data, which may indicate purchases contemplated or completed by the user, content sold, content price, royalty information, license numbers, inventory ID numbers, transactional IDs, etc.

The collected data may also include location or demographic data. The location data may relate to the demographic environment at the location of the remote device, i.e., print/design advertising or products associated with remote device, kiosk location, seismic/meteorological activity, local advertisements, local artists, local event calendaring, and so forth.

The collected data also includes financial data. The financial data may include sales transaction data, which may indicate purchases contemplated or completed by the user, content sold, content price, royalty information, inventory ID numbers, transactional IDs, etc. Examples of other types of financial data include payment information, sales information, credit/debit/gift card information, promotional/discount codes, accounting information, and so forth.

The kiosk can operate in either a continuous or a batch mode. In the continuous mode of operation, the collected data for each transaction is transmitted quickly from the kiosk to the server. Then, the collected data is deleted from the memory of the kiosk without storing the data at that particular kiosk. In the batch mode, the collected data for each transaction is retained at the kiosk until such time as the kiosk transmits all of collected data at once.

The collected data may be shared with any external party of the system 5. The collected data can be shared with the external party by either transmitting the data to them or by allowing them to access the system either directly or indirectly through a Web page/Web portal that is part of the electronic network. In the former situation, the collected data may be optionally collated, analyzed, summarized, or otherwise processed using a variety of steps. This situation may allow the operator of the system to perform the analysis, filter the results, and/or customize the data that is sent to the external party. In the latter situation, the external party can view the collected data before (or as) it is received from the kiosk(s) or anytime during the analysis, filtering, or customization process. Of course, access to the system by the external party can be established using any parameters desired by the operator of the system and/or the individual user that provided the data, i.e., access may be limited to only certain portions of the collected data.

In certain situations, the collected data can be sent directly to other kiosks or shared with a web solution. Such situations can be advantageous when the external party wants to access data from a group of kiosks in the same location or vicinity (i.e., a primary and a secondary kiosk). In these situations, the data can be transmitted to-or-from the secondary kiosk, allowing the external party to access the collected data for both the primary and the secondary kiosks. This situation may give the external party more access to the raw data that has been collected, but does not necessarily allow the operator of the system to analyze, filter, or customize the report. Again, access to the collected data can be established using any parameters desired by the operator of the system, i.e., access may be limited to only certain portions of the collected data.

In some embodiments, the collected data may be purposefully reported to location partners 40 or content providers 30, including copyright owners. If content providers, copyright owners, or others are due royalties or other payments based on use or sale of content, such royalties or other payments may be made from the operator of a server to the appropriate recipient using automated means known in the art, based upon sales and demographic data. A system operator can also authorize any third party to receive reports and restrict the reports that the third party can access.

All of the collected data from the distribution device(s), Web portal, and/or Web page can be used for numerous purposes. In some aspects, the collected data can be used to enhance and/or customize the operation of the system. In other aspects, the collected information can be part of the general and specific market research data that can be used by the operator of the system as known in the art. In yet other aspects, the collected information can be used to customize the content and/or the advertising provided to the user (both current advertising and future advertising). For example, the collected data can be used to customize the content delivered to the kiosk or be used to predict the types/genre of media that will be popular to a given user. Alternatively, the collected data can be used to customize the digital content by the time of day, the geographic location, etc. In some embodiments, the collected data can then be used to customize the advertising for an individual attendee or a group of attendees. Since some of the collected data includes user's feedback of the digital content, the collected data can be used to rate the digital content being purchased or rented.

The collected data can be used to customize the advertising directed to the user. The advertising may include messages used to market, promote, or sell products or services; or to enhance brand recognition, as well as training materials, entertainment content, community or location information, and other similar materials. The advertising may also include video clips, audio clips, ring tones, printed coupons, promotional codes, brochures, literature, images, giveaways, discounts associated with digital content, or other promotional or brand-related content. In some embodiments, the advertising may be presented through video and/or audio presentations, animated PowerPoint presentations, flash programs, banners, pop-ups, screen-savers, wallpapers, posters, digital sampling, cost-per-pixel, cost-per-click, advertisement images, printed advertisements, trademarks and other similar advertisements. One example of the advertising includes the promotion of artists whose products or content are available for sale on the kiosk. In still another example of the use of the collected data, it may be used in any method of viral marketing.

The user does not need to physically present at a kiosk to interact with it. The user can interact with the kiosk via a Web portal that is in communication with the kiosk. In some embodiments, this communication can comprise a wired connection, such as a user accessing the Web page or Web portal via a desktop computer. In other embodiments, though, the communication can comprise a wireless connection, such as a user accessing the Web page or Web portal via portable electronic device, like a cellular telephone using SMS technology, which may or may not be the same as the receiving device.

In some embodiments, when a user purchases or rents content through a kiosk 20, that content is made available to the user using any receiving device known in the art. The receiving device can be provided by the kiosk 20 or can be provided by the user (i.e., it can be the same as the portable electronic device provided by the user). Non-limiting examples of some content receiving devices can include playback devices or storage devices. Examples of the playback devices include portable computers, MP3 players, iPods®, video players, or mobile/cellular phones. Examples of the storage devices include portable computers, mobile/cellular phones, pagers, text messaging devices, calendar or text information devices, recordable media such as memory chips and cards, CDs and DVDs (or similar video or data discs), writeable data CD such as WORM or CD-RAM, flash drives, USB sticks, or flash memory storage devices. The digital content may be stored on these receiving devices magnetically, optically, or electronically as well as any other storage mode known in the art. In some aspects, the digital content can be placed on a receiving device, along with migrated plug-ins or software that can be used to play the digital content received.

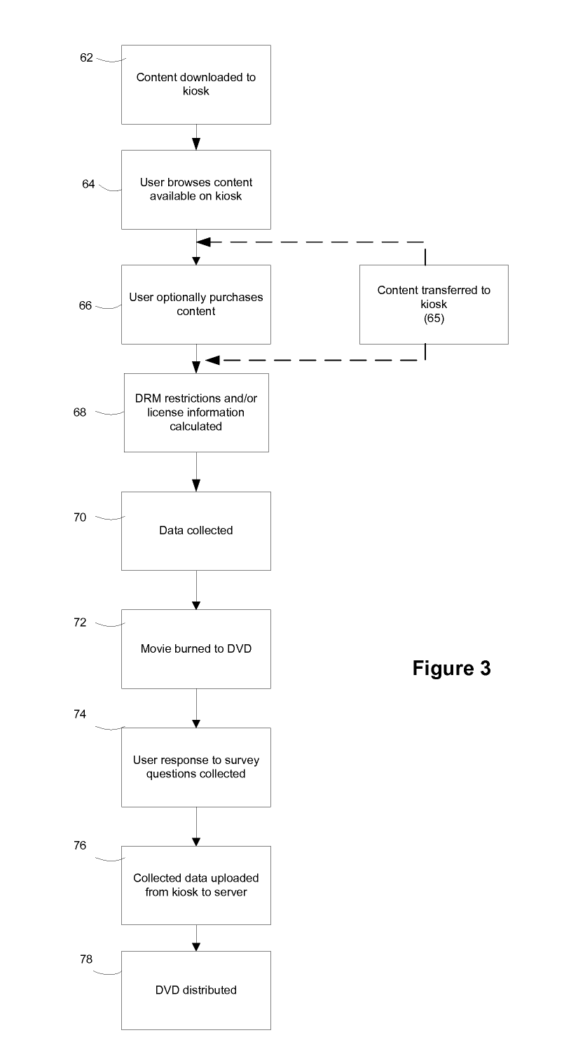

Although a user may interact with the kiosk 20 in any manner, an example of a typical user interaction with kiosk 20 is illustrated in FIG. 3. Nevertheless, one skilled in the art will appreciate that many variations are possible as to the processes followed by a particular user and that the following process need not be followed sequentially. One example of a typical user's interaction with the kiosk is illustrated in FIG. 3. Block 62 of FIG. 3 shows that if the digital content is not already present at the kiosk, it may be transferred to the kiosk. At block 64 in FIG. 3, the user can optionally view advertising on the first video screen and may optionally begin to use an input device (i.e., touch screen display) located on or adjacent to the kiosk to navigate among a collection of content that is available for review, rental, or sale via the kiosk. At that point, the user may optionally experience samples of content via the first or second video screen or another output device located on or adjacent to the kiosk. For example, the user can listen to the first 30 seconds of a music file that is available for purchase via the kiosk (or that is available anywhere in the system).

Next at block 66, the user can then optionally select the content to be purchased, typically by paying a purchase price, and entering payment information that is appropriate to the transaction. This payment information can then be verified in real-time. Additionally, the user can take advantage of multiple payment methods, i.e., cash, credit, debit, promotions, loyalty programs, reward programs, etc.

At block 68 in FIG. 3, the method may continue when DRM restrictions and/or license information are calculated as needed and associated with the digital content that was selected for purchase. As shown at block 72, the user can select medium and/or a receiving device onto which the content 16 will be placed for the user and the content 16 may then be delivered to that device. Then the user may continue to input information during the remainder of the transaction. For instance, block 74 shows that after the user has selected a receiving device for the purchased content, the user may answer a survey or in other way reveal user data, kiosk data, location data, or any other information. This process may optionally be completed while payment information is being authenticated, while content is being downloaded in real-time (if necessary based on the current state of the digital content), and while content is transferred from the kiosk to the selected receiving device.

In some embodiments, the desired content may not already reside on the kiosk 20. In these embodiments, an additional transfer process can be performed. In this transfer process, the desired content is transferred to the kiosk using the system 5, as shown in block 65. This transfer may happen after the selection process or after the purchase process.

At any time during the interaction, the kiosk may gather collected data from the user, as illustrated at block 70. The kiosk may gather any desired information (i.e., user data, kiosk data, location data) at any point in the method when that data is available for collection. The kiosk 20 may then assemble the user data, kiosk data, location data, and any other information into the collected data and communicate it to the server 10 (or any other device), as shown at block 76.

As shown at block 72, the user can select the medium (i.e., a DVD or a flash drive) onto which the content will be transferred and the content may be delivered to the selected medium. In some embodiments, the content is transferred to medium which is provided by the distribution device (i.e., a blank DVD) which is then dispensed to the user. In other embodiments, the content can be transferred directly to a flash drives that is provided by a user.

Then the user may continue to input information during the remainder of the transaction. For instance, block 74 shows that after the user has selected a medium for purchased content, the user may answer a survey or in other way reveal user data, kiosk data, community data, or any other information. This step may optionally be completed while payment information is being authenticated, while content is being downloaded in real-time (if necessary based on the current state of the semi-dynamic content), and while content is transferred from the kiosk to the selected medium.

The kiosk 20 may then assemble the user data, kiosk data, location data, and any other information into the collected data and communicate it to the server 10 (or any other device), as shown at block 76. Any device or apparatus that can collect and gather such data can be used. Examples of such devices may include data gathering devices, such as hand-held units, as well as the hardware and software components in the kiosk 20 mentioned above.

When the server 10 receives the collected data, it may be optionally collated, analyzed, summarized, or otherwise processed on a server using a variety of steps. The server 10 may also be configured to use the collected data from one or more kiosks 20 as a factor in determining what content to push and store at each kiosk 20, what advertising messages to push to each kiosk 20, etc.

The collected data can then be shared and made available to any external parties of the system. For example, if a community of users has been formed, any desired collected data may be shared among the community, including making the data about a particular community available to a single user or even a non-user of that community. In another example, the collected data can be shared with a content provider 30 or a location provider 40.

The collected data may be communicated to any external party using any known technique. For example, in one technique, communication among a community may be initiated by the user using, for example, instant messaging, blogs, e-mail, EDI, or uploading of data to a separate computer that is accessible to one or more members of the community. In a second technique, the external party may be provided with access to the server 10 on which kiosk data is stored, or another server controlled by the same or an affiliated entity that controls the server. This technique permits the external party to access the collected data at times determined by them. One example of a method by which an external party may access the collected data on a server 10 is via a Web page provided by the entity that controls the server 10. In one embodiment, this Web page may be provided by the same Web server that provides a Web page embodiment of a kiosk 20, with the server 10 providing appropriate information.

As depicted at 78 in FIG. 3, the medium (i.e., the DVD) containing the selected digital content (i.e., movie) is then dispensed to the user. Block 78 can also be part of a rental process, where the DVD with the movie is returned at a later date. Block 78 can also be part of a purchase process where the DVD containing the movie is kept by the user.

The methods and systems described above may have any desired variation. For instance, in one variation, a user can interact with a kiosk 20 to select and purchase content, but selects a delivery location that is not co-located with the kiosk 20 at which the original interaction and purchase occurred (the “delivery location”). As one example, a user could interact with a server using a Web page embodiment of a kiosk 20 and then select a separate kiosk 20 having a DVD-burning output device as the delivery location. As a second non-limiting example, a user could interact with a server 10 via a first kiosk 20 having two video displays and a DVD burner, but then discover that the preferred delivery mechanism, a DVD, was unavailable because all blank DVDs at that particular kiosk 20 had been used. The user could then select as the delivery location a kiosk 20 located in another building on the same campus where blank DVDs were available; or the user could select a Web page embodiment as the delivery location and a download to hard disk as the delivery mechanism.

In another variation, the entity that operates a server 10 or kiosk 20 may receive a fee or services in exchange for its part in the collection and sharing of information. In another variation on the systems and methods described above, a first device comprises a kiosk and the second device comprises a peripheral that may optionally be located remotely from that kiosk. In some embodiments, several kiosks may be networked together to act as distribution nodes in a distribution chain.

In still another variation, multiple kiosks 14 may be linked in a manner such that purchases are completed on one or more kiosks 20 but the delivery location for all such purchases is a designated delivery device located on a specific kiosk 20. As one example, a retail establishment could maintain multiple kiosks 14 at which customers could browse available content. After purchase of content through any of those multiple kiosks 14, all customers would collect the DVD video disk from a separate kiosk 20 that was designed for high-volume generation of such devices.

In addition, the interaction with the kiosk experience can be customized for each kiosk's location. For example, the kiosk can be customized for a demographic in that location where it is located. In this example, if the kiosk is located in a demographic with a large number of Spanish speaking users, the interface, digital content stored at the kiosk, and any other operating parameter can be customized for a Spanish speaking user.

The kiosks may also vend or offer additional services including services allowing an upload of data for storage. For example, a kiosk may allow a user's camera full of pictures to upload the pictures stored on the camera, have them stored in the system and then retrieved later either through a kiosk or by transferring them via the Web portal.

In other variations, the payment for the digital content could be made while the user is located at the kiosk, but the digital content can be delivered in another location. Thus, for example, the user can purchase in one location and retrieve the digital content in another location. These other locations include another kiosk or even an electronic device at another location, such as a desktop computer located at the user's home or office.

In this variation, the system 5 can be modified to allow a user to select a movie using an electronic device other than the kiosk. The user can connect to the system 5 using the electronic network (i.e., access the system 5 via the internet). Once connected, the user can then browse, select, and/or purchase the desired movie. The user can then specify the location of the kiosk for delivery of the DVD. The user can access the system 5 using any electronic device with suitable connection capability, i.e., a desktop computer, a laptop computer, a cell phone or other portable electronic device. Such embodiments can be very useful, for example, when a user is traveling to the location where the kiosk is located. The user can browse, select, and purchase the movie while traveling to the location and once arrived, immediately pick up the DVD containing the movie with no wait.

In other variations, the user who retrieves the digital content can be different than the user who selects and/or pays for the content. For example, a first user select digital content from a first kiosk and a second user could take delivery of that content at a second kiosk. Thus, the first user could select and optionally purchase content while in New York and the second user who is traveling in Los Angeles could go to a kiosk and take delivery of that content there after proper verification and/or identification procedures at the second kiosk. In some instances, the first user could be a parent and the second user could be a child that can retrieve the DVD using a user name and password set by the parent.

Using the apparatus described above provides several features. First, when a DVD that has been returned becomes damaged, it is easy to replace. In conventional apparatus, a damaged DVD must be thrown away and a replacement DVD obtained via shipping and manually inserted in its place. This process takes time and creates additional expense. The kiosks 20 described above can easily detect and discard a damaged DVD and then quickly create a replacement, eliminating the associated costs and delays experienced by conventional kiosks.

A similar feature is that the consumers who purchase a DVD can easily obtain a replacement for the DVD (or CD) they have purchased through the kiosk. One of the problems faced by purchasers is that the medium (especially a DVD and a CD) that is purchased through normal retail outlets can eventually become damaged over time. The purchaser is faced with buying a replacement DVD at full cost to continue using the digital content. But with the kiosks, the purchaser can merely return the purchased DVD and a replacement copy of the DVD can be created for the purchaser. In other embodiments, the purchaser can provide an email address and they could receive a digital copy of the content via email or they could provide an electronic storage device (i.e., a flash drive) and the kiosk could transfer another copy to that device. In yet other embodiments, the purchaser could be given the option to pay an extra fee to have insurance on the content they purchased, and that option can be offered—and paid for—both before or after the content is purchased. These actions could be taken by direct contact with the kiosk and/or via the electronic network. Thus, the insurance option could be paid over the electronic network if the purchaser could prove that the content was purchased by using a username and/or password or even by using metadata that is associated with the content (i.e., a content identifier).

The kiosks 20 are capable of creating DVDs on a near real-time basis. Thus, a consumer's choice is not limited to the inventory on hand that have been shipped and placed in the machine. Thus, more choices are available for the consumer since the choice is not limited to the existing inventory, i.e., the stock on hand that have been shipped and placed in the machine. This results in less choice for the consumer. For example, DVDs containing popular movies are often out of stock and can't be rented in some conventional kiosks.

The kiosks 20 are also capable of operating on an automated or semi-automated basis. Some conventional kiosks require a high degree of manual labor to operate. All of the DVDs must be shipped to the operator, who must then travel to each retail location where the kiosks are located and insert new DVDs, remove old DVDs, remove damaged DVDs, and otherwise maintain the machines. Such manual labor increases the difficulties and costs of operating these kiosks. The kiosks 20 (as well as the system 5 containing the server 10) can be operated with little to no manual intervention. In other words, the kiosk 20 can manufacture the DVDs for rental or for purchase on-the-fly. The kiosk 20 can control the inventory of movies by manufacturing more DVDs when it is getting low or by discarding DVD when they are damaged or there are too many are in the kiosk. Thus, the kiosks 20 do not depend on physical DVDs to be shipped and manually placed into the kiosk like conventional apparatus.

Another feature is that if a given kiosk is getting low on a new release of a movie, the kiosk could start making additional copies of that DVD so that the kiosk never ran out of inventory for that movie. Any extra DVDs that were produced (i.e., or a new release) could be put in a disposal bin so that the kiosk did not run out of storage. Similarly, a kiosk would create DVDs with new releases of movies before the official release date of that movie so that new releases would be available at 12:01 am on the release date.

Yet another feature is the communication between kiosks about inventory of a given movie. For example, if a first kiosk was in a first location (i.e., downtown) and users would pick a given DVD up from that first kiosk but then return the DVD to a second kiosk in a second location, then the first kiosk (when notified that the DVD was returned to the second location) could create a new DVD for its inventory and the second kiosk one could discard the DVD if it was overstocked with that DVD.

Having described the preferred aspects of the devices and associated methods, it is understood that the appended claims are not to be limited by particular details set forth in the above description, as many apparent variations thereof are possible without departing from the spirit or scope thereof.

1. A distribution device for dispensing a DVD, comprising:
a connection to an electronic communications network for receiving digital content in an electronic format;
a device for converting the digital content from the electronic format onto a DVD; and
an opening for dispensing the DVD containing the digital content to a user.

2. The device of claim 1, wherein the digital content comprises a movie or a video.

3. The device of claim 1, further comprising an input device allowing a user to select the desired content before it is converted.

4. The device of claim 3, wherein the selection and the conversion occur on a substantially real time basis.

5. The device of claim 3, further comprising transferring the digital content to the device from another location in an electronic network after the user has made the selection.

6. The device of claim 1, wherein the distribution device comprises a kiosk.

7. The device of claim 1, further comprising a device for detecting and discarding damaged DVDs.

8. A system for dispensing a DVD, comprising:
an electronic communications network containing a server; and
a kiosk containing:
a connection to the electronic communications network for receiving digital content in an electronic format;
a device for converting the digital content from the electronic format onto a DVD; and
an opening for dispensing the DVD containing the digital content to a user.

9. The system of claim 8, wherein the digital content comprises a movie or a video.

10. The system of claim 8, wherein the kiosk further comprises an input device allowing a user to select the desired content before it is converted.

11. The system of claim 10, wherein the selection and the conversion occur on a substantially real time basis.

12. The system of claim 10, further comprising downloading the digital content to the kiosk from another location in the network after the user has made the selection.

13. The system of claim 8, the kiosk further comprising a device for detecting and discarding damaged DVDs.

14. A method for distributing DVDs to a user from a kiosk, the method comprising:
providing a kiosk containing a connection to an electronic communications network for receiving digital content in an electronic format, a device for converting the digital content from the electronic format onto a DVD, and an opening for dispensing the DVD containing the digital content to a user;
allowing a user to select any desired digital content;
converting the digital content from the electronic format onto the DVD; and
dispensing that DVD from the kiosk to the user.

15. The method of claim 14, wherein the digital content comprises a movie or a video.

16. The method of claim 14, wherein the selection and the conversion occur on a substantially real time basis.

17. The method of claim 14, further comprising transferring the digital content to the kiosk from another location in the network after the user has made the selection.

18. The method of claim 14, wherein the digital content already resides on the kiosk prior to selection.

19. The method of claim 14, further comprising detecting and discarding damaged DVDs.

20. The method of claim 14, wherein the user selects any desired digital content using the kiosk.

21. The method of claim 14, wherein the kiosk can detect the number of existing DVDs for any given digital content and convert that digital content from the electronic format onto the DVD prior to a user selecting that digital content.
